(19) United States
(12) Patent Application Publication
(10) Pub. No.: US 2010/0244297 A1
(43) Pub. Date: Sep. 30, 2010

(54) MOLDING APPARATUS

(75) Inventor: Shusaku NISHIYAMA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/732,651

(22) Filed: Mar. 26, 2010

(30) Foreign Application Priority Data
Mar. 26, 2009 (JP) 2009-77293

(51) Int. Cl. B29C 47/92

(52) U.S. Cl. 264/40.5; 425/149; 425/144

(57) ABSTRACT

A molding apparatus includes two metal molds arranged at positions opposing to each other and each having a die for molding a member into a desired shape, a heating unit for heating the member, an ultrasonic wave transmitting and receiving unit arranged on the metal mold for irradiating the member with an ultrasonic wave and receiving the reflected ultrasonic wave, a drive unit for driving at least one of the metal molds and a control unit for detecting a partial contact of the member with respect to the metal mold using wave readings from the ultrasonic wave transmitting and receiving unit and controlling the drive unit to adjust a pressing velocity of the metal mold.

### CROSS-REFERENCE TO RELATED APPLICATIONS

This application is based upon and claims the benefit of priority of the prior Japanese Patent Application No. 2009-77293, filed on Mar. 26, 2009, the entire contents of which are incorporated herein by reference.

### FIELD

The embodiments discussed herein are related to a molding apparatus.

### BACKGROUND

Optical components to be built in an electronic apparatus include a component formed by processing a surface of a thin and transparent sheet member. For example, a light guide panel used in a liquid crystal display device of a mobile phone set or a backlight device of the liquid crystal display device is manufactured by forming a surface of a transparent resin sheet such as polycarbonate or olefin resin into a desired shape. Since such an optical component is very thin and hence is difficult to manufacture by resin injection molding, it is manufactured using a heat press molding method such as a hot emboss molding method in many cases.

In a heat press molding apparatus, the shape of a metal mold surface is transferred to a surface of the resin sheet by clamping the thin resin sheet as a molding material between heated metal molds while pressurizing and softening the same. Since the metal mold is heated, a surface portion of the resin seat close to the metal mold is brought into a molten state, so that the surface portion of the resin sheet can be molded into the shape of the surface of the metal mold easily.

In the heat press molding apparatus in the related art, control of a metal mold closing action is performed by position-speed control in many cases. In other words, it is determined that the metal mold comes into contact with the molding material at a time point when the metal mold is moved to a predetermined position, and then the metal mold is compressed by a predetermined distance to achieve the press molding. In this case, whether or not the surface portion is brought into the molten state after the molding material has come into contact with the metal mold is not determined, and it is determined to be in the molten state at the time point when a predetermined time has elapsed after the metal mold has come into contact with the molding material, and thereafter the procedure proceeds to a pressing work.

In the position-speed control, although the determination that the metal mold comes into contact with the molding material is not performed in general, there may be a case where it is determined that the metal mold comes into contact with the molding material by sensing the fact that a reaction force is applied to the metal mold by a contact with the molding material. In order to detect the reaction force, a load cell provided on a moving mechanism of the metal mold may be used. Alternatively, the fact that the reaction force is applied may be detected from a change of a drive current of a motor for driving the metal mold.

However, the determination of the contact on the basis of the detection of the reaction force as described above is not sufficiently accurate. For example, since the resin seat is melted and brought into a liquid state by contact with the metal mold, there is a case where the reaction force can hardly be generated. In such a case, the metal mold may be compressed beyond a contact point without detection of the reaction force (without being determined to be in contact).

In the position-speed control, determination of whether or not the transfer of the shape of the surface of the metal mold is completed is not performed after having proceeded to the pressing work, and it is assumed that the transfer is completed by the fact that the metal mold is compressed to the predetermined position. The reason why the determination of whether or not the transfer of the shape of the surface of the metal mold is completed is not performed is because the shape of transfer is fine and is invisible because it is hidden by the metal mold, so that there is no means for confirming the progress of transfer.

The timing to start a mold opening process (mold release process) after a pressing process is determined to be a time point when the predetermined time is elapsed after the pressing process is ended and the metal mold is left closed for cooling. In other words, the mold opening (mold release process) is started after having waited a lapse of time which is assumed to be required for solidification of the molten portion of the resin sheet whether or not the molten portion of the resin sheet is solidified instead of determining whether or not the molten portion of the resin sheet is solidified.

As described above, in the heat press molding apparatus in the related art, the molten state or the state of solidification of the molding material cannot be determined, and hence the contact of the metal mold, the pressing process, and the mold opening process (mold release process) cannot be performed with a high degree of accuracy.

Japanese Laid-open Patent Publication No. 10-178289 discloses detection of the state of solidification or the molten state of a molten substance in the metal mold by means of ultrasonic wave.

### SUMMARY

According to an aspect of the embodiment, a molding apparatus includes two metal molds arranged at positions opposing to each other and each having a die for molding a member into a desired shape, a heating unit for heating the member, an ultrasonic wave transmitting and receiving unit arranged on the metal mold for irradiating the member with an ultrasonic wave and receiving the reflected ultrasonic wave, a drive unit for driving at least one of the metal molds and a control unit for detecting a partial contact of the member with respect to the metal mold using wave readings from the ultrasonic wave transmitting and receiving unit, and for controlling the drive unit to adjust a pressing velocity of the metal mold.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a simplified configuration drawing showing an entire heat press molding apparatus;

FIG. 2 is a drawing for explaining the state of a molding material and the change of an ultrasonic wave reflective echo during a heat press molding process;

FIG. 3 is a simplified drawing showing part of the molding apparatus according to an embodiment;

FIG. 4 is a drawing showing an ultrasonic reflective echo image when an upper molding die comes into contact with the molding material;

FIG. 5 is a drawing of a structure in which a lower molding die is heated by an electromagnetic induction heating coil;

FIG. 6 is a flowchart of the heat press molding process performed by the heat press molding apparatus according to the embodiment;

FIG. 7 is a graph showing temperatures of the molding die and the molding material, positions of the mold, and a transfer internal pressure during heat press molding;

FIG. 8 is a drawing for explaining detection of a metal mold touch;

FIGS. 9A and 9B are drawings for explaining reflective echo imaging and the detection of the metal mold touch and detection of the metal mold touch position;

FIG. 10 is a drawing for explaining reflective echo imaging and determination of the completion of filling;

FIGS. 11A and 11B are drawings for explaining the determination of completion of filling;

FIG. 12 is a drawing for explaining reflective echo imaging and determination of completion of solidification; and

FIGS. 13A and 13B are drawing for explaining reflective echo imaging and the determination of the completion of solidification

### DESCRIPTION OF EMBODIMENTS

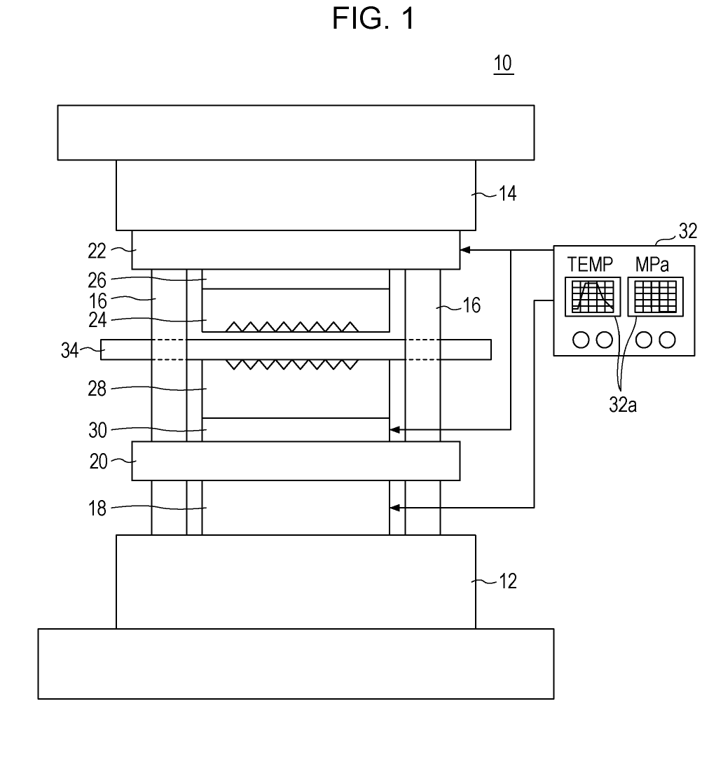

FIG. 1 is a simplified configuration drawing showing an entire molding apparatus. The molding apparatus shown in FIG. 1 is a heat press molding apparatus 10, and is an apparatus for transferring and molding a fine shape to the surface of a molding material such as plastic or glass.

The heat press molding apparatus 10 includes a lower fixed base 12 and an upper fixed base 14. The lower fixed base 12 and the upper fixed base 14 are connected at a predetermined distance by a plurality of tie bars 16. The lower fixed base 12 is provided with a press mechanism 18. The press mechanism 18 is a known reciprocal movement mechanism and, for example, a toggle ink mechanism driven by a hydraulic cylinder or an electric actuator is used.

A movable platen 20 is movably mounted along the tie bars 16 by the press mechanism 18. The fixed platen 22 is mounted on the upper fixed base 14. Therefore, by driving the press mechanism 18, the movable platen 20 can be moved toward and away from the fixed platen 22.

An upper molding die 24 is mounted on the fixed platen 22 via a heater plate 26. Therefore, the upper molding die 24 can be heated by the heater plate 26. In contrast, a lower molding die 28 is mounted on the movable platen 20 via a heater plate 30. Therefore, the lower molding die 28 can be heated by the heater plate 30. The upper molding die 24 and the lower molding die 28 form a molding die (metal mold). The lower molding die 28 can be moved toward the upper molding die 24 (mold closing), or the lower molding die 28 can be moved away from the upper molding die 24 (mold opening) by moving the movable platen 20 by the press mechanism 18.

A control unit 32 for controlling the action of the apparatus is provided in the heat press molding apparatus 10. Excitation of the above-described heater plates 26, 30 is controlled by the control unit 32. Also, the drive of the press mechanism 18 is controlled by the control unit 32. The control unit 32 includes a screen display device 32a, so that input information to the heat press molding apparatus 10, and the positions or the temperatures of the molding die can be displayed on the screen display device 32a.

Molding of the molding material 34 is performed as follows.

First of all, in a state in which the molding die including the upper molding die 24 and the lower molding die 28 is opened, the heater plates 26, 30 are excited to heat the upper molding die 24 and the lower molding die 28. When the temperature of the upper molding die 24 and the lower molding die 28 reach a predetermined heating temperature Th, a molding material 34 is arranged between the upper molding die 24 and the lower molding die 28. Here, the predetermined heating temperature Th is, for example, a temperature higher than a glass transfer temperature Tg of the molding material 34 (Th=Tg+α).

When the molding material 34 is arranged between the upper molding die 24 and the lower molding die 28, the press mechanism 18 is driven to perform the mold closing. In other words, by moving the movable platen 20 toward the fixed platen 22, the molding material 34 is interposed between the lower molding die 28 and the upper molding die 24. When the molding material 34 is interposed between the lower molding die 28 and the upper molding die 24, the surface of the molding material 34 is heated by the lower molding die 28 and the upper molding die 24 and is brought into the molten state.

Accordingly, the lower molding die 28 is moved further toward the upper molding die 24 to pressurize the molding material 34. This step is a press deformation step. In the press deformation step, portions of the molding material 34 in the molten state in the vicinity of the surfaces thereof are pressed against surfaces of the upper molding die 24 and the lower molding die 28. The portions of the molding material 34 in the molten state in the vicinity of the surfaces thereof are filled in projections and depressions formed on the surfaces of the upper molding die 24 and the lower molding die 28.

When the press deformation step is ended, the excitation of the heater plates 26, 30 is stopped, and the pressurizing state of the upper molding die 24 and the lower molding die 28 is maintained. This step is a cooling step. In the cooling step, since heating of the upper molding die 24 and the lower molding die 28 is stopped, the temperatures of the upper molding die 24 and the lower molding die 28 are lowered to a cooling temperature Tc which is lower than the glass transfer temperature Tg of the molding material 34 (Tc=Tg−β). Accordingly, the surface temperature of the molding material 34 also falls below the glass transfer temperature Tg, and the molten molding material 34 filled in the projections and depressions geometries formed on the surfaces of the upper molding die 24 and the lower molding die 28 is solidified. Accordingly, the projections and depressions geometries on the surfaces of the upper molding die 24 and the lower molding die 28 are transferred to the surface of the molding material 34.

When the cooling step is ended, the press mechanism 18 is driven to perform the metal mold opening, and the molded molding material 34 is released and taken out from the molding die, whereby the heat press molding process is ended.

In the heat press molding as described above, when the molding process is started, if the molding die is rapidly closed and the upper molding die 24 comes into contact with the molding material 34, a reaction force of the molding material 34 is abruptly generated, so that the upper molding die 24 may become damaged. Therefore, control to lower the speed of the metal mold closing so as to come into contact slowly is performed. Therefore, a mold closing step takes time and the time required for the molding process is elongated. Therefore, detecting the contact is obtainable by detecting the reaction force of the molding material 34. However, since the upper molding die 24 comes into contact with the molding material 34 slowly, the surface of the molding material 34 is melted and is brought into a liquid state during contact, so that the reaction force may become far from being generated. In this case, the reaction force of the molding material 34 cannot be detected, and hence detection of the contact is not achieved.

Also, in the press deformation step which is performed after having closed the molding die, determination of whether or not the molten molding material 34 is sufficiently filled in the projections and depressions on the surface of the molding die is not achieved. In other words, since the molding die is closed, an actual state of transfer cannot be grasped, and hence the completion of the transfer cannot be grasped, events such that the molding die is excessively pressed, or the press molding time is set to a length longer than necessary may result.

In addition, in the cooling step after a press deformation step, the state of solidification of the molding material 34 melted and filled in the projections and depressions of the surface of the molding die cannot be grasped. Therefore, the cooling step may be set to a period excessively long for safety and, in this case, a heat press molding cycle (time period required for molding one molding material 34) is elongated.

Accordingly, in the embodiment, the molding material 34 is irradiated with an ultrasonic wave during the heat press molding process, and the molten state and the state of solidification of the molding material 34 are detected on the basis of the ultrasonic wave reflective echo therefrom.

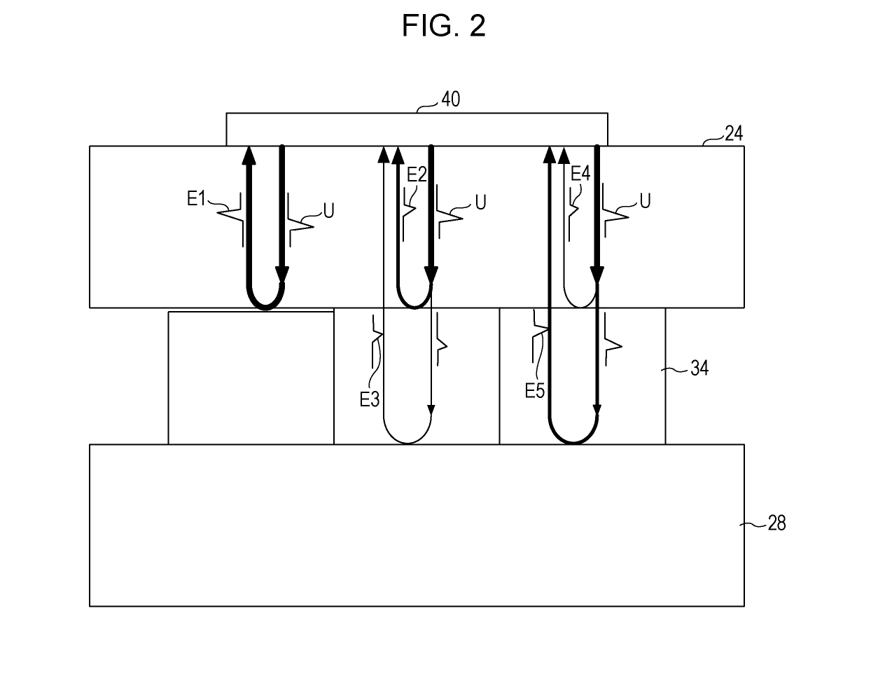

FIG. 2 is a drawing for explaining the state of the molding material 34 and the change of the ultrasonic wave reflective echo during the heat press molding process. In order to irradiate the molding material 34 sandwiched in the molding die with the ultrasonic wave, an ultrasonic wave oscillating/receiving array 40 is mounted on the molding die as a reflective ultrasonic wave oscillating/receiving device. In the example shown in FIG. 2, the ultrasonic wave oscillating/receiving array 40 is attached to the upper molding die 24. The ultrasonic wave oscillating/receiving array 40 includes a number of ultrasonic wave oscillating/receiving elements having pairs of an ultrasonic wave oscillating element and an ultrasonic wave receiving element arranged in two-dimensional matrix pattern. The respective ultrasonic wave oscillating/receiving elements are able to oscillate the ultrasonic wave and receive the reflective echo thereof. Each ultrasonic wave oscillating/receiving element which has received the reflective echo outputs a signal which indicates the intensity of the reflective echo. The ultrasonic wave oscillating/receiving element may be configured to output a signal which indicates the phase of the reflective echo if necessary. It is assumed that a resin sheet is used as the molding material 34.

First of all, ultrasonic waves oscillated and received when the upper molding die 24 is not in contact with the molding material 34 will be described.

When the upper molding die 24 is not in contact with the molding material 34, a void is present between the surface of the upper molding die 24 and the surface of the molding material 34 as shown on the left side in FIG. 2. In this state, an ultrasonic wave U oscillated from the ultrasonic wave oscillating/receiving array 40 is totally reflected from the surface of the upper molding die 24, and almost 100% of the ultrasonic wave U is returned to the ultrasonic wave oscillating/receiving array 40 as an ultrasonic wave reflective echo E1. When the ultrasonic wave U is totally reflected from the surface of the upper molding die 24, the phase of the ultrasonic wave reflective echo E1 is inverted. Therefore, the ultrasonic wave reflective echo E1 received by the ultrasonic wave oscillating/receiving array 40 is an ultrasonic wave having substantially the same intensity as, and a phase inverted from, the ultrasonic wave U oscillated from the ultrasonic wave oscillating/receiving array 40.

Subsequently, the ultrasonic waves oscillated and received at a time point when the upper molding die 24 is brought into tight contact with the molding material 34 will be described.

Immediately after the contact of the upper molding die 24 with respect to the molding material 34, as shown at the center in FIG. 2, the surface of the upper molding die 24 is in contact with the surface of the molding material 34 in the solid state before melting. In this state, although most of the ultrasonic wave U oscillated from the ultrasonic wave oscillating/receiving array 40 is reflected from the surface of the upper molding die 24, some components proceed straight ahead and enter the molding material 34. The ultrasonic wave reflected from an interface between the upper molding die 24 and the molding material 34 is not inverted in phase, and returns to the ultrasonic wave oscillating/receiving array 40 as an ultrasonic wave reflective echo E2 while keeping the same phase.

The ultrasonic wave having entered into the molding material 34 without being reflected from the interface between the upper molding die 24 and the molding material 34 propagates in the molding material 34, reaches the interface between a lower surface of the molding material 34 and the lower molding die 28 and is reflected therefrom, and propagates again in the molding material 34 as an ultrasonic wave reflective echo E3. Then, the ultrasonic wave reflective echo E3 returns back to the interface between the upper surface of the molding material 34 and the upper molding die 24, proceeds straight ahead as is, enters the upper molding die 24, and returns back to the ultrasonic wave oscillating/receiving array 40.

Therefore, there are two ultrasonic wave reflective echoes received by the ultrasonic wave oscillating/receiving array 40 for the ultrasonic waves U oscillated from the ultrasonic wave oscillating/receiving array 40. One of them is an ultrasonic wave reflective echo E2 being weaker than the oscillated ultrasonic wave U but having a certain intensity and having the same phase as the oscillated ultrasonic wave U, and the other one is the ultrasonic wave reflective echo E3 being weaker than the ultrasonic wave reflective echo E2 and having the same phase as the oscillated ultrasonic wave U.

Subsequently, the ultrasonic waves oscillated and received at the time point when the surface of the molding material 34 is melted after the upper molding die 24 has been brought into contact with the molding material 34 will be described.

When the upper molding die 24 comes into contact with the molding material 34 and the molding material 34 is heated, the surface of the molding material 34 is melted as shown on the right side in FIG. 2, and the surface of the upper molding die 24 is brought into a state of being in contact with the molten liquid state molding material 34. In this state, although part of the ultrasonic wave U oscillated from the ultrasonic wave oscillating/receiving array 40 is reflected from the surface of the upper molding die 24, most of the wave proceeds straight ahead and enters the molding material 34. Part of the ultrasonic wave U reflected from the interface between the upper molding die 24 and the molding material 34 is not inverted in phase, and returns to the ultrasonic wave oscillating/receiving array 40 as an ultrasonic wave reflective echo E4 while keeping the same phase.

The ultrasonic wave having entered into the molding material 34 without being reflected from the interface between the upper molding die 24 and the molding material 34 propagates in the molding material 34, reaches the interface between the lower surface of the molding material 34 and the lower molding die 28 and is reflected therefrom, and propagates again in the molding material 34 as an ultrasonic wave reflective echo E5. Then, the ultrasonic wave reflective echo E5 returns back to the interface between the upper surface of the molding material 34 and the upper molding die 24, proceeds straight ahead as is, enters the upper molding die 24, and returns back to the ultrasonic wave oscillating/receiving array 40.

Therefore, there are two ultrasonic wave reflective echoes received by the ultrasonic wave oscillating/receiving array 40 for the ultrasonic waves U oscillated from the ultrasonic wave oscillating/receiving array 40. One of them is the ultrasonic wave reflective echo E4 being much weaker than the oscillated ultrasonic wave U and having the same phase as the oscillated ultrasonic wave U, and the other one is the ultrasonic wave reflective echo E5 being stronger than the ultrasonic wave reflective echo E4 and having the same phase as the oscillated ultrasonic wave U.

As described above, since the intensity or the phase of the ultrasonic wave reflective echo varies depending on the contact state of the molding die with respect to the molding material 34 and the molten state or the state of solidification of the molding material 34, the state of the molding material 34 can be obtained by detecting the intensity or the phase of the ultrasonic wave reflective echo.

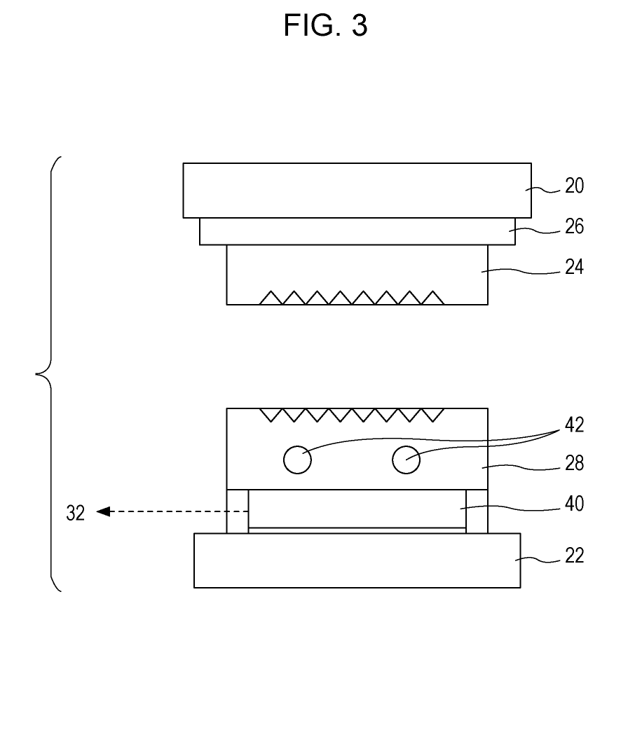

Referring now to FIG. 3, the heat press molding apparatus will be described as an example of the molding apparatus according to the embodiment. FIG. 3 is a simplified drawing showing part (platen and molding die) of the molding apparatus according to the embodiment.

The heat press molding apparatus according to this embodiment is the same as the heat press molding apparatus 10 shown in FIG. 1 in basic structure. However, as shown in FIG. 3, the side where the movable platen 20 is placed is assumed to be an upper side, and the side where the fixed platen 22 is placed is assumed to be a lower side. Therefore, the press mechanism 18 is provided between the movable platen 20 placed on the upper side and the upper fixed base 14, and the movable platen 20 moves upward and downward with respect to the fixed platen 22 placed on the lower side.

The upper molding die 24 is mounted on the movable platen 20 via the heater plate 26. The upper molding die 24 can be heated by exciting the cartridge heater 42 and heating thereby.

The lower molding die 28 is mounted on the fixed platen 22 via the ultrasonic wave oscillating/receiving array 40 instead of the heater plate 30. In the interior of the lower molding die 28, a cartridge heater 42 is built in, so that the lower molding die 28 can be heated by exciting the cartridge heater 42 and heating thereby.

In the heat press molding apparatus having a configuration as described above, the molding material 34 is irradiated with the ultrasonic wave over the substantially entire surface from the ultrasonic wave oscillating/receiving array 40 during the heat press molding process, and the ultrasonic wave reflective echo is detected to create an ultrasonic wave reflective echo image. By grasping the intensity of the ultrasonic wave reflective echo and the presence or absence of the inversion of the phase if necessary from the ultrasonic wave reflective echo image, the state of the molding material 34 can be determined.

As shown in FIG. 3, when the cartridge heater 42 is provided in the interior of the lower molding die 28, the cartridge heater 42 extends between the ultrasonic wave oscillating/receiving array 40 and the surface of the lower molding die 28. In this case, when the ultrasonic wave oscillating/receiving array 40 oscillates the ultrasonic wave and receives the ultrasonic wave reflective echo from the surface of the lower molding die 28, the ultrasonic wave is reflected from the cartridge heater 42 at a portion where the cartridge heater 42 extends and hence the ultrasonic wave reflective echo is generated. Therefore, the cartridge heater 42 is captured in the ultrasonic wave reflective echo image, and the state of the ultrasonic wave reflective echo from the surface of the molding die cannot be determined therefrom.

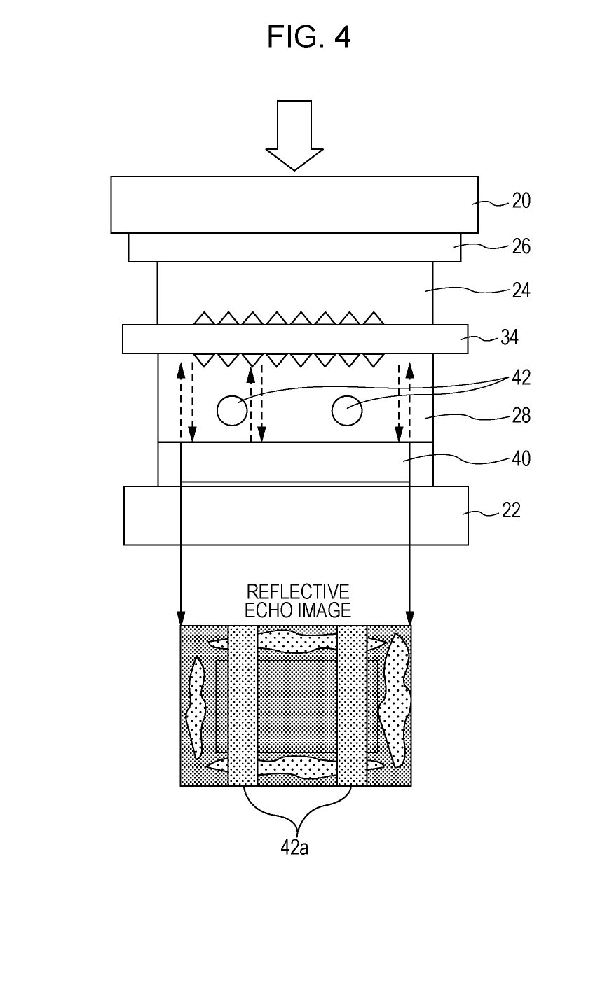

An example in which the cartridge heater 42 is captured in the ultrasonic wave reflective echo image will be described with reference to FIG. 4. FIG. 4 is a drawing showing the ultrasonic wave reflective echo image for determining the fact that the lower molding die 28 comes into contact with the molding material 34 (hereinafter, referred to as “mold touch”) after having moved the upper molding die 24 downward to close the mold.

The control unit 32 oscillates the ultrasonic wave from the ultrasonic wave oscillating/receiving array 40, and receives the signal indicating the intensity and the phase of the ultrasonic wave reflective echo from the surface of the lower molding die 28 from the ultrasonic wave oscillating/receiving array 40. The control unit 32 creates the ultrasonic wave reflective echo image on the basis of the intensity and the phase of the ultrasonic wave reflective echo and the intensity of the oscillated ultrasonic wave, and displays the same on the screen display device 32a. Image processing is applied to the ultrasonic wave reflective echo image, so that the intensity of the ultrasonic wave reflective echo and the presence or absence of the phase inversion are recognized. The image processing is also done by the control unit 32. A method of determining the mold touch from the ultrasonic wave reflective echo image as such will be described later.

In the ultrasonic wave reflective echo image shown in FIG. 4, two thick lines 42a extending in the vertical direction appear. This is the image of the cartridge heater 42, and this portion is not the image formed by the ultrasonic wave reflective echo from the surface of the lower molding die 28, so that it does not serve as a determination image for determining the mold touch. In other words, the surface area of the ultrasonic wave reflective echo image as a criteria of determination of the mold touch is reduced by an amount corresponding to the image of the cartridge heater 42. If the surface area of the image of the cartridge heater 42 is relatively smaller than the entire part of the ultrasonic wave reflective echo image, influence on the mold touch determination is small. However, if elimination of the influence of the image of the cartridge heater 42 is wanted, the lower molding die 28 may be heated from the outside instead of embedding the cartridge heater 42 in the lower molding die 28.

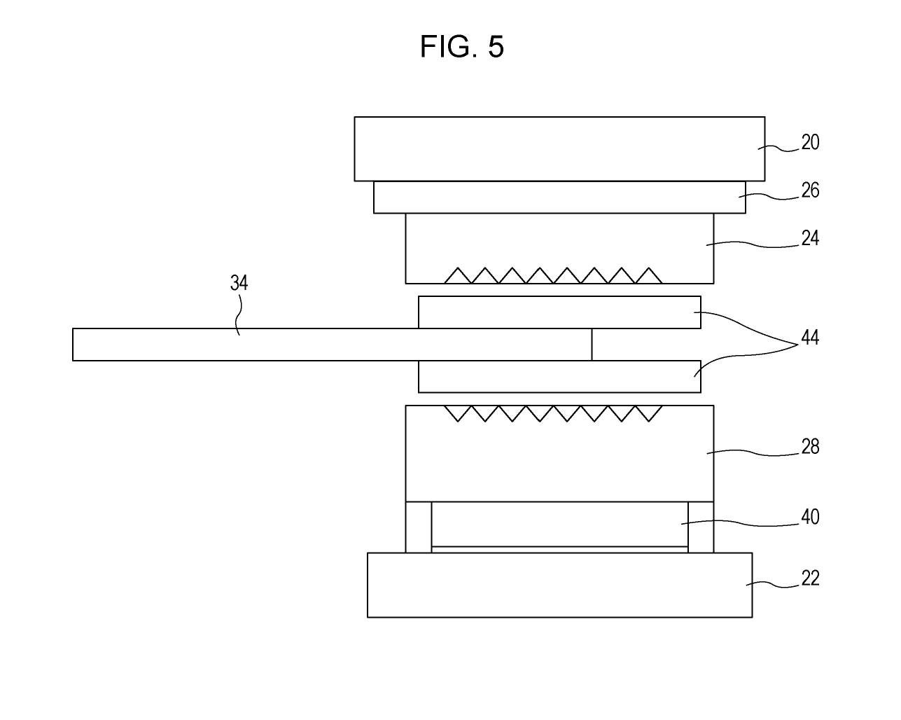

FIG. 5 is a drawing of a structure in which the lower molding die is heated by an electromagnetic induction heating coil. No cartridge heater is built in the lower molding die 28. Instead, an electromagnetic induction heating coil 44 is arranged between the upper molding die 24 and the lower molding die 28 in a state in which the molding die is opened, so that the lower molding die 28 is heated by electromagnetic induction heating. When heating of the lower molding die 28 is ended, the electromagnetic induction heating coil 44 is removed, and the molding material 34 is inserted between the upper molding die 24 and the lower molding die 28 instead, and then the mold is closed to perform the heat press molding. A heating method for heating the lower molding die 28 from the outside is not limited to the electromagnetic induction heating, and heating by another heating method using an electric heating, an infrared-ray heater, a heating lamp or the like is also applicable. Also, the upper molding die 24 as well as the lower molding die 28 may be heated from the outside.

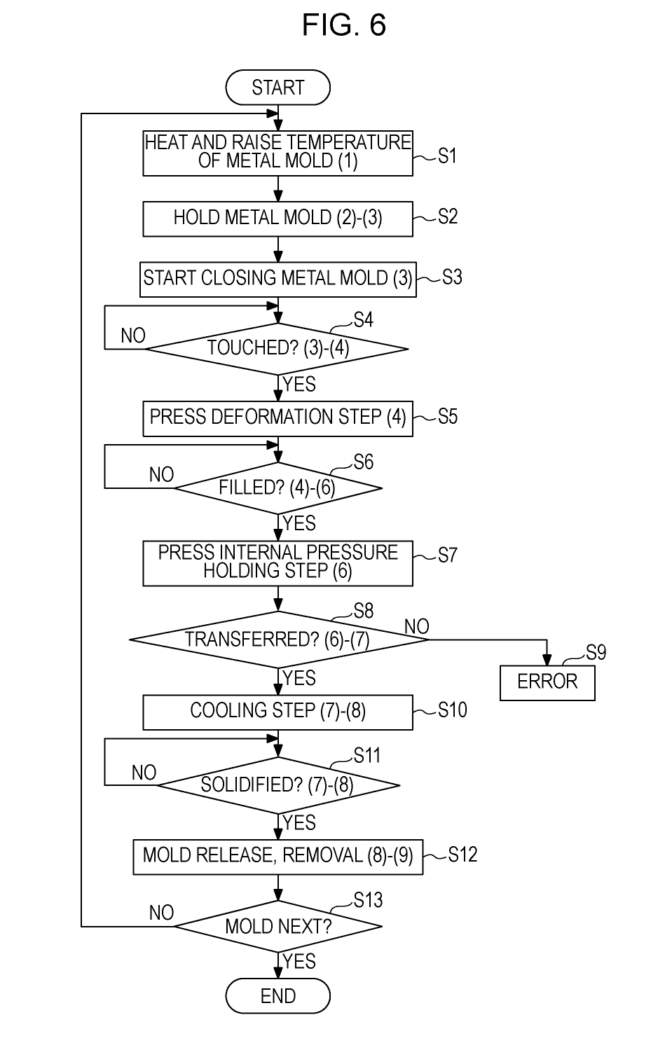

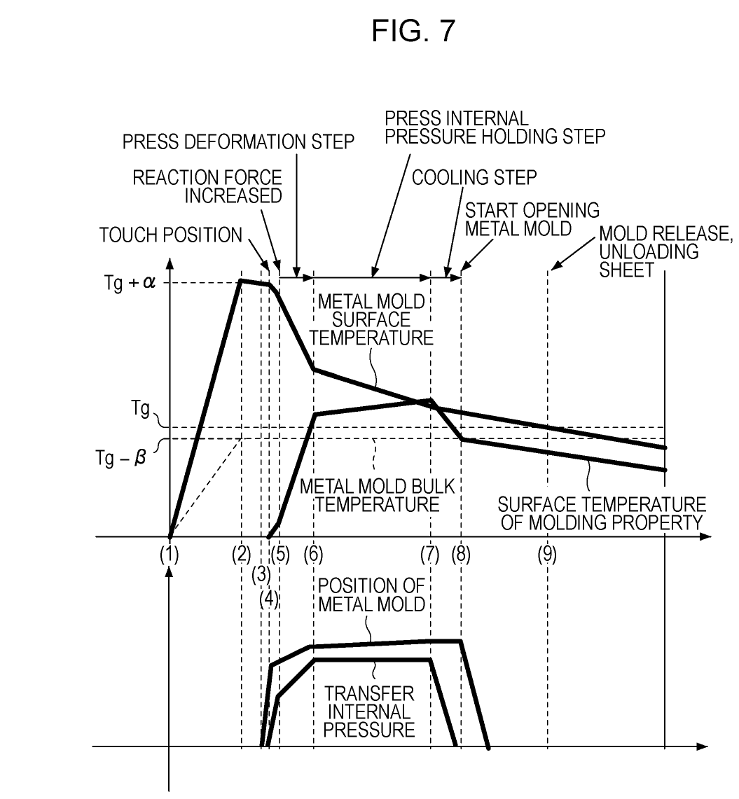

The heat press molding process performed by the heat press molding apparatus according to the embodiment is described with reference to FIG. 6. FIG. 6 is a flowchart of the heat press molding process performed by the heat press molding apparatus according to this embodiment. Description will be given under the assumption that the heat press molding process is performed by the heat press molding apparatus configured to heat the lower molding die 28 by the electromagnetic induction heating coil 44 shown in FIG. 5. FIG. 7 is a graph showing temperatures of the molding die and the molding material, positions of the upper molding die (die position), and the pressure of the transferred portion of the molding material 34 (transfer internal pressure) during heat press molding. The parenthesized numerals in FIG. 7 correspond to steps with the same parenthesized numerals in FIG. 6.

When the heat press molding is started, first of all, in Step S1, the molding die is heated to bring surface temperatures Tms of the upper molding die 24 and the lower molding die 28 to a temperature not lower than the glass transfer temperature Tg of the molding material (Tms=Tg+α). Here, by setting the value of α to 50° C. to 100° C., for example, falling of the surface temperature of the die below the glass transfer temperature Tg is prevented immediately even when the molding die comes into contact with the molding material 34 and heat is transferred to the molding material 34.

Subsequently, in Step S2, the molding die is kept opened for a predetermined short time for averaging the surface temperature of the die. When the predetermined short time is elapsed, the procedure goes to Step S3, where the mold closing is started.

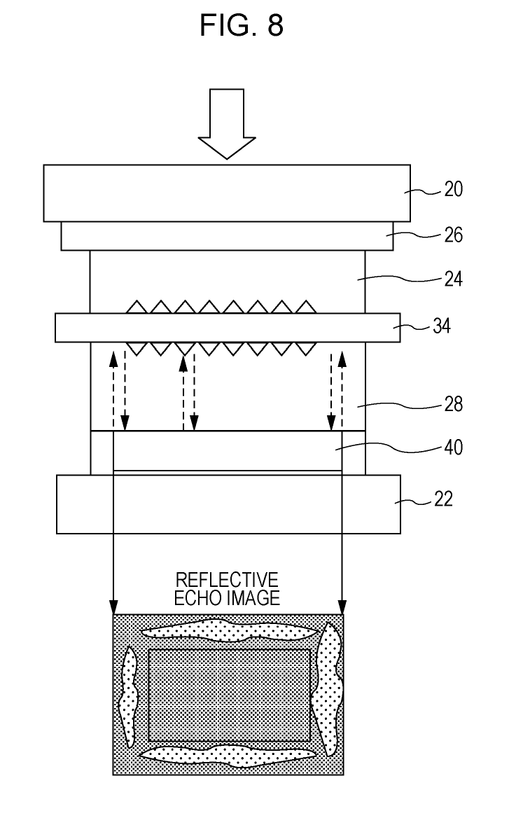

Subsequently, in Step S4, whether or not the mold is touched is determined. Determination of the mold touch is performed in the following manner. First of all, when the upper molding die 24 approaches the mold touch position, a mold closing velocity is reduced while continuing to proceed to the mold closing, then the molding material 34 is irradiated with the ultrasonic wave from the ultrasonic wave oscillating/receiving array 40 via the lower molding die 28 as shown in FIG. 8, so that the ultrasonic wave reflective echo image is created. Then, the ultrasonic wave reflective echo image is continuously monitored, and the change of the ultrasonic wave reflective echo image in association with the progress of the metal mold closing is obtained.

The ultrasonic wave reflective echo image is created by the control unit 32 on the basis of the signals indicating the intensities of the oscillated ultrasonic waves and the signals indicating the intensities and the phases of the ultrasonic wave reflective echoes outputted from the respective ultrasonic wave elements of the ultrasonic wave oscillating/receiving array 40. The control unit 32 displays the created ultrasonic wave reflective echo image on the screen display device 32a, and determines the mold touch from data of the displayed image in the following manner.

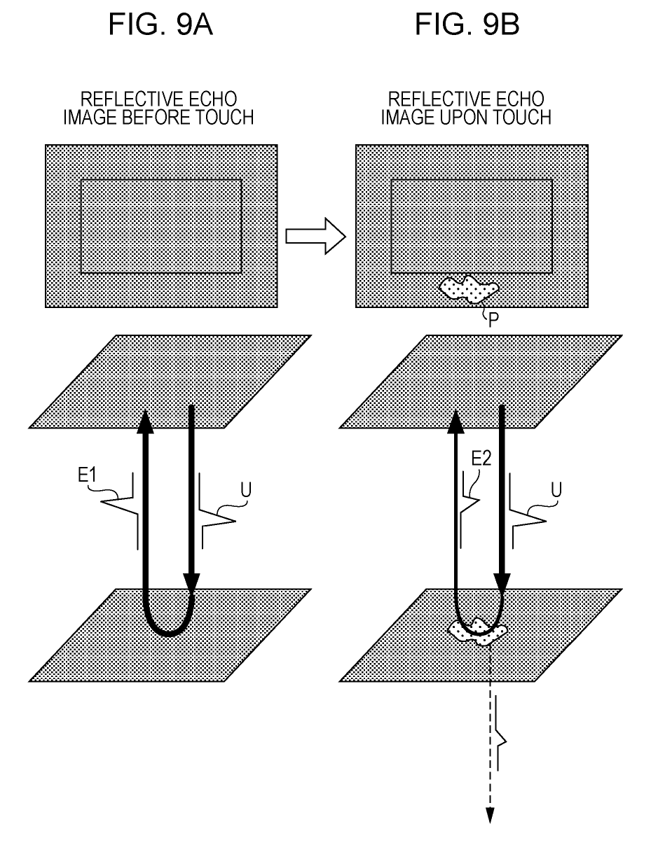

In the determination of the mold touch, whether a portion where the ultrasonic wave reflective echo is weak appears in the ultrasonic wave reflective echo image is confirmed. Before the mold touch, the ultrasonic wave reflective echo image appears as a strong ultrasonic wave reflective echo over the entire display as shown in FIG. 9A. In other words, since the molding material 34 is not pressurized against the lower molding die 28 before the mold touch, an air layer (that is, void) is present between the molding material 34 and the lower molding die 28. Therefore, as described in conjunction in FIG. 2, the ultrasonic wave is totally reflected from the interface between the molding material 34 and the lower molding die 28, and the strong ultrasonic wave reflective echo having the inverted phase is returned to the ultrasonic wave oscillating/receiving array 40. The image of the ultrasonic wave reflective echo at this time is shown in FIG. 9A. If the returned portion of the ultrasonic wave reflective echo having the inverted phase and the high intensity is configured to be colored with, for example, dark red by the image processing, the entire ultrasonic wave reflective echo image is colored with dark red before the mold touch.

Here, the level of the intensity of the ultrasonic wave reflective echo which is determined as the strong intensity is determined on the basis of conditions such as the material of the molding die or the state of the surface thereof. For example, when the intensity of the ultrasonic wave to be emitted from the ultrasonic wave oscillating/receiving array 40 is assumed to be 100%, the ultrasonic wave reflective echo is determined to be the strong level when the intensity of the ultrasonic wave reflective echo has the intensity from the 100% to 80% of the intensity of the emitted ultrasonic wave.

When the mold closing is proceeded, the mold touch occurs. In this embodiment, since a pattern to be transferred (fine projections and depression geography) is formed at the center portion of the lower molding die 28, the contact of the lower molding die 28 with respect to the molding material 34 starts from part of an outer peripheral portion where the pattern to be transferred is not formed. When the part of the lower molding die 28 comes into contact with the molding material 34 and is compressed to some extent, the air layer at this portion is no longer present, and the lower molding die 28 is brought into tight contact with the molding material 34. At this time, although the portion in tight contact with the lower molding die 28 is heated by the lower molding die 28 and hence is increased in temperature, the temperature does not reach a melting temperature (the temperature not lower than the glass transfer point) immediately. Therefore, the interface of a portion where the molding material 34 is in tight contact with the lower molding die 28 corresponds to the interface between a metal and a solid resin. The ultrasonic wave reflective echo in such the interface becomes the ultrasonic wave reflective echo having a medium level intensity weaker than the emitted ultrasonic wave and the same phase as shown in FIG. 2.

If the returned portion of the ultrasonic wave reflective echo having the same phase and the middle intensity is configured to be colored with, for example, pink by the image processing, only the part where the molding material 34 is in tight contact with the lower molding die 28 is changed into pink. The ultrasonic wave reflective echo image at this time is shown in FIG. 9B. In FIG. 9B, an area indicated by the reference sign P is an area changed into pink.

As a criteria of the mold touch, for example, the time point when the pink area appears in the ultrasonic wave reflective echo image can be recognized as the mold touch. Alternatively, it is also applicable to determine that the mold touch occurs when the pink area exceeds, for example, 30% of the entire ultrasonic wave reflective echo image. The extent of the tight contact area (pink area) to be determined as the mold touch is preferably set adequately by considering various conditions such as the material, the shape, or the state of the surface of the molding material 34 or the material, the shape, or the state of the surface of the molding die. For example, in this embodiment, when the intensity of the ultrasonic wave to be emitted from the ultrasonic wave oscillating/receiving array 40 is assumed to be 100%, the ultrasonic wave reflective echo is determined to be the middle level when the intensity of the ultrasonic wave reflective echo has the intensity from 40% to 80% of the intensity of the emitted ultrasonic wave.

When it is determined that the mold touch occurs in Step S4, the procedure goes to Step 5. In Step S5, the press deformation step is started. In the press deformation step, the molding material 34 is pressurized while further reducing the velocity of the upper molding die 24. At this time, the temperature of the surface of the molding material 34 which is in tight contact with the heated lower molding die 28 and the upper molding die 24 is increased to a level not lower than the glass transfer temperature, so that the surface of the molding material 34 is brought into the molten state. Therefore, transfer patterns of the upper molding die 24 and the lower molding die 28 are pressed on the molten molding material 34, the molten molding material 34 is filled into the transfer patterns.

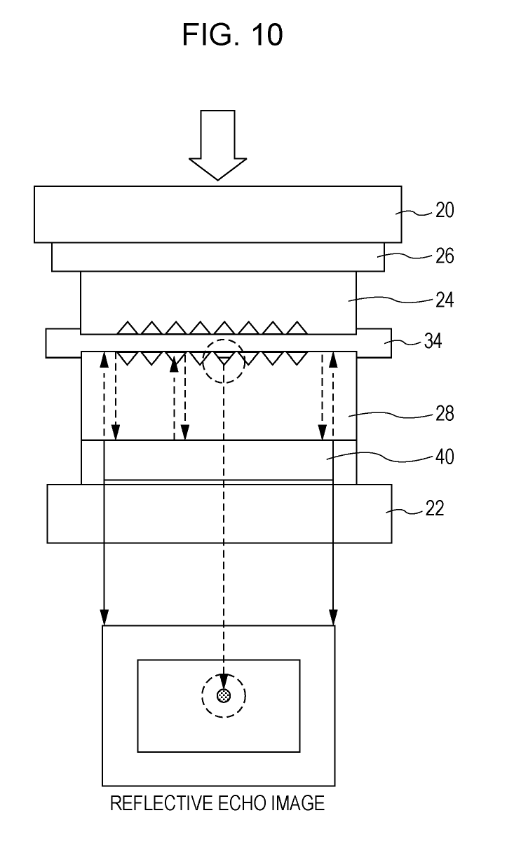

Subsequently, in Step S6, whether or not the molding material 34 is filled completely over the entire transfer patterns (filling completed, or transfer completed) is determined. Determination of the filling completed or the transfer completed is performed in the following manner. First of all, the molding material 34 is irradiated with the ultrasonic wave from the ultrasonic wave oscillating/receiving array 40 via the lower molding die 28 as shown in FIG. 10 while pressurizing the molding material 34 between the upper molding die 24 and the lower molding die 28, so that the ultrasonic wave reflective echo image is created. Then, the ultrasonic wave reflective echo image is continuously monitored, and the change of the ultrasonic wave reflective echo image in association with the progress of the pressurizing is obtained.

The ultrasonic wave reflective echo image is created by the control unit 32 on the basis of the signals indicating the intensities of the oscillated ultrasonic waves and the signals indicating the intensities and the phases of the ultrasonic wave reflective echoes outputted from the respective ultrasonic wave elements of the ultrasonic wave oscillating/receiving array 40. The control unit 32 displays the created ultrasonic wave reflective echo image on the screen display device 32a, and determines the filling completed or the transfer completed from data of the displayed image in the following manner.

In the determination of the filing completed or the transfer completed, whether the portion where the ultrasonic wave reflective echo is strong remains in the ultrasonic wave reflective echo image is confirmed. When the press deformation step is started, the molten molding material 34 comes into tight contact with the surface of the lower molding die 28. In this portion, the state shown on the right side in FIG. 2 is assumed, and the ultrasonic wave reflective echo in a weak level is returned to the ultrasonic wave oscillating/receiving array 40. In other words, the molding material 34 in the liquid state comes into tight contact with the portion which is in tight contact with the molding material 34 in the solid state and the depressions of the transfer pattern where air used to be present. At this time, the ultrasonic wave reflective echoes in a strong level (the state in which the air is present) and a middle level (the state of being in contact with the solid substance) are changed to the ultrasonic wave reflective echoes in the weak level. Then, if the image processing is applied to the ultrasonic wave reflective echo image so as to change the color of the portion of the image where the ultrasonic wave reflective echo in the weak level is returned into, for example, white, the dark red area and the pink area is changed gradually to white as the pressurization is proceeded.

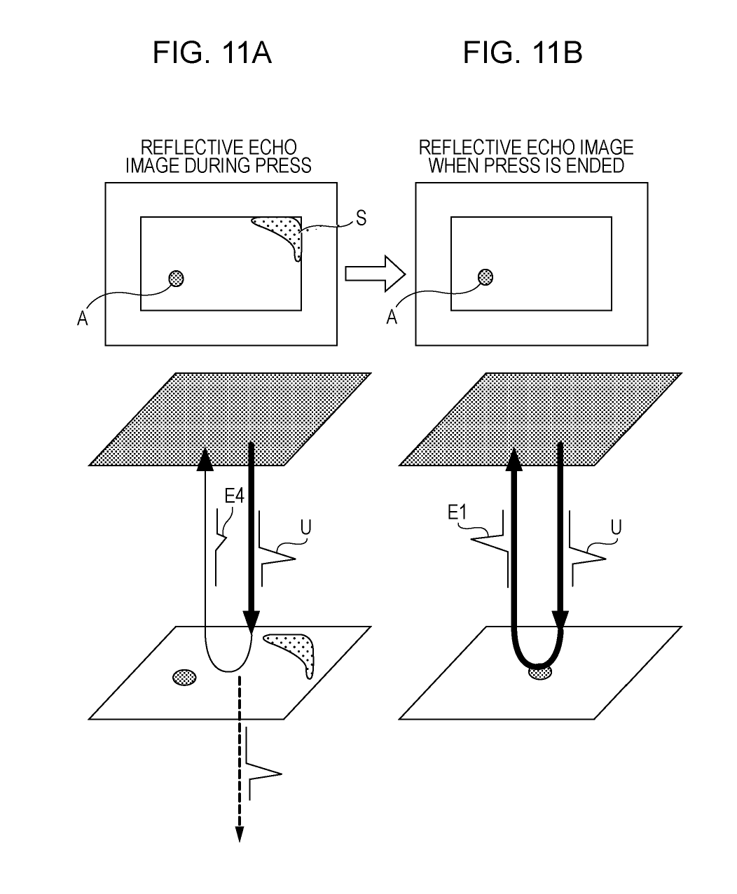

The image of the ultrasonic wave reflective echo during the pressurization is shown in FIG. 11A. In the image of the ultrasonic wave reflective echo shown in FIG. 11A, most part of the area is white and hence it is understood that the molten molding material 34 is in tight contact with the surface of the lower molding die 28. However, the area indicated by a reference sign A is still in dark red, and the area indicated by a reference sign S is still in pink.

The dark red area indicated by the reference sign A shows that the air still remains in this area between the molding material 34 and the lower molding die 28, and the molding material 34 is not in tight contact with the surface of the lower molding die 28, that is, the molten molding material 34 is not filled in the transfer patterns. Also, the pink area indicated by the reference sign S shows that the molding material 34 is not melted in this area yet and the molding material 34 in the solid state is in tight contact with the surface of the lower molding die 28.

When the pressurization is further proceeded from the state shown in FIG. 11A, the pink portion indicated by the reference sign S is changed into white, and the ultrasonic wave reflective echo image shown in FIG. 11B is assumed. In other words, the portion where the molding material 34 remains in the solid state is also melted, and the molding material 34 in the liquid state is brought into the state of being in tight contact with the surface of the lower molding die 28. Here, it is understood that the dark red area indicated by the reference sign A remains in the ultrasonic wave reflective echo image shown in FIG. 11B. In this area, the air remains between the molding material 34 and the lower molding die 28 as described above, and the molding material 34 is not in tight contact with the lower molding die 28. In other words, the ultrasonic wave reflective echo image shown in FIG. 11B shows the facts that the air is trapped in the depression of the transfer pattern as shown in FIG. 10, and that the molding material 34 is not filled in the corresponding portion.

The determination of the filling completed may be performed at the time point when the dark red area and the pink area in the ultrasonic wave reflective echo image are all changed to white. However, since the filling is proceeded also in the internal pressure holding step performed subsequently, it is also possible to determine that the filling is completed at the time point when the white area reaches 90% in the ultrasonic wave reflective echo image. Since the dark red area may remain by the air trapped in part of the transfer pattern as shown in FIG. 11B, the determination of the filling completed may be performed even when the dark red area or the pink area remain to some extent as long as it does not cause a problem as a product. The criteria of the determination of the filling completed is not limited to 90%, and is preferably set to an adequate value as needed according to the molding conditions or characteristics of the product.

When it is determined that the filling is completed in Step S6, the procedure goes to Step S7, and is transferred to the press internal pressure holding step. In the press internal pressure holding step, the internal pressure in the molding material 34 by the pressurization from the molding die is maintained and filling of the molten molding material 34 further in the transfer pattern is awaited. In the press internal pressure holding step, the pressurization of the molding die continues to an extent that the internal pressure is held.

Subsequently, in Step S8, whether or not the molten molding material 34 is filled completely over the transfer patterns (transfer completed) is determined. In other words, the ultrasonic wave reflective echo image is monitored continuously after having determined to be filled completed, and it is determined to be a defective transfer when the white area in the ultrasonic wave reflective echo image does not reach 99% or higher of the entire ultrasonic wave reflective echo image, if so the procedure goes to Step S9. In Step S9, the control unit 32 emits an alarm to notify an operator that the defective transfer occurs. When the defective transfer is notified, the operator stops the operation of the heat press molding apparatus, and the molding material 34 which is subjected to the defective transfer is taken out from the molding die, and then the heat press molding cycle can be started again. Alternatively, it is also possible to perform mold release to take out the molding material 34 with defective transfer after the procedure goes to a cooling step, described later, as in the normal case, and treat the corresponding molding material 34 as the defective mold even though the alarm is emitted in Step S9.

In contrast, when the white area in the ultrasonic wave reflective echo image reaches 99% or higher of the entire ultrasonic wave reflective echo image within a predetermined time in Step S8, it is determined that the transfer is completed, and the procedure goes to Step S10. In Step S10, the cooling step is started. In the cooling step, the movement of the molding die is stopped and this state is maintained, and then the solidification of the molten portion of the molding material 34 is awaited. When the cooling step is started, then whether or not the molten portion of the molding material 34 is solidified (solidification completed) is determined in Step S11. Determination of the solidification completed is performed as follows.

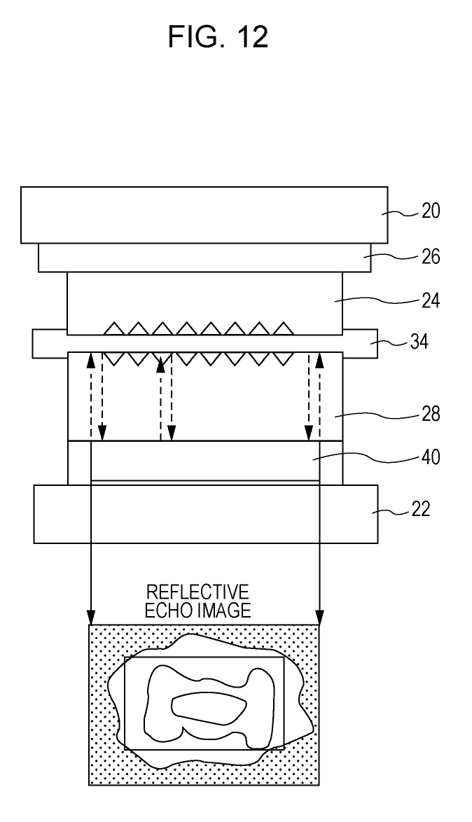

First of all, the molding material 34 is irradiated with the ultrasonic wave from the ultrasonic wave oscillating/receiving array 40 via the lower molding die 28 as shown in FIG. 12 while holding and cooling the molding material 34 between the upper molding die 24 and the lower molding die 28, so that the ultrasonic wave reflective echo image is created. Then, the ultrasonic wave reflective echo image is continuously monitored, and the change of the ultrasonic wave reflective echo image in association with the solidification of the molding material 34 by cooling is obtained.

In the determination of the solidification completed, the percentage of area where the ultrasonic wave reflective echo is at the middle level is confirmed. At the time point of the transfer completed, most of the ultrasonic wave reflective echo image is white. However, when the procedure is transferred to the cooling step, the white portion is changed to pink again. In other words, since the molten molding material 34 is cooled and hence solidified, the intensity of the ultrasonic wave reflective echo in the solidified portion becomes the middle level (ultrasonic wave reflective echo E2 in FIG. 2), and the corresponding area is displayed in pink.

Here, in Step S11, when the area having a predetermined percentage with respect to the entire ultrasonic wave reflective echo image is solidified, it is determined that the solidification is completed. In this embodiment, the determination of the solidification completed is done at the time point, for example, when the pink area reaches 30% to 50% of the entire ultrasonic wave reflective echo image. The predetermined percentage is the percentage of the portion where the molding material 34 is solidified, and is set to a percentage which allows easy mold release of the molding material 34 when the metal mold opening is started.

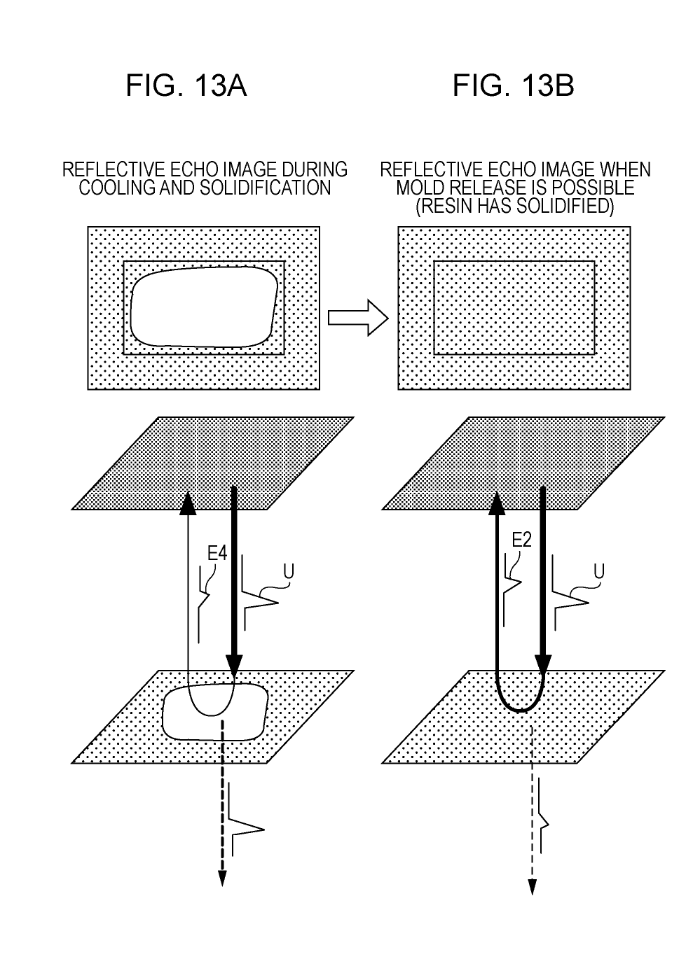

Normally, the solidification of the molding material 34 starts from the outer peripheral portion (easily cooled portion) of the molding die. Therefore, the solidification of the molding material 34 starts from the outer peripheral portion thereof as shown in FIG. 13A. In this embodiment, when the pink area reaches 50% as shown in FIG. 13A, it is determined that the solidification is completed. If the cooling step is continued as is, the entire portion of the molding material 34 is solidified, and the ultrasonic wave reflective echo image is finally changed entirely to the pink area as shown in FIG. 13B. Since it takes a long time until the state shown in FIG. 13B is achieved, in this embodiment, at the time point when the state shown in FIG. 13A is assumed, it is determined that the solidification is completed.

When it is determined that the solidification is completed in Step S11, the procedure goes to Step S12. In Step S12, the molding die is opened and the molding material 34 is released, and the molding material 34 having completely molded is taken out from the molding die. Here, although one molding cycle is ended, whether or not there is a next molding to be performed is determined in Step S13 and, if yes, the procedure goes back to Step S1, where the next molding is performed. When the molding is performed continuously, the die bulk temperature is maintained until the next molding cycle is started, and a state of readiness for starting the next molding cycle immediately is preferably assumed.

As described above, in this embodiment, since the heat press molding process is proceeded while determining the state of the molding material on the basis of the strength of the ultrasonic wave reflective echo from the interface between the molding die and the molding material, the time required for the molding process can be reduced, and occurrence of the defecting molding can be restrained. Also, the defective transfer can be determined in the state in which the molding material is in the molding die.

In the embodiment described above, the ultrasonic wave oscillating/receiving array 40 is used as the ultrasonic wave oscillating/receiving device, and the state of the molding material is determined by creating the ultrasonic wave reflective echo image corresponding to substantially the entire surface area of the molding material 34. However, the ultrasonic wave oscillating/receiving device is not limited thereto. For example, it is also possible to determine the state of the molding material 34 by determining a plurality of reference positions for determining the state of the molding material 34 in advance as the ultrasonic wave oscillating/receiving device and detecting the intensities of the ultrasonic wave reflective echo at these positions. As the plurality of reference positions may be, for example, three positions including a position corresponding to the outer periphery of the molding material 34, a position corresponding to the center of the molding material 34, and a position located at the intermediary therebetween may be determined in advance. In this case, direct determination is achieved by using the values of intensity of the ultrasonic wave reflective echo (intensity levels) at the above-described three points instead of the determination using the ultrasonic wave reflective echo image.

For example, when the surface area of the molding material 34 is small and the molten state or the state of solidification of the entire molding material 34 can be determined by the determination of only one point, the ultrasonic wave oscillating/receiving device must simply be provided with the pair of ultrasonic wave oscillating element and the ultrasonic wave receiving element. In other words, it is also possible to determine the state of the molding material directly without creating the ultrasonic wave reflective echo image using the value of the intensity of the ultrasonic wave reflective echo (intensity level) at one point.

In the embodiment described above, the transfer pattern is formed on both the lower molding die 28 and the upper molding die 24. However, the transfer pattern does not necessarily have to be formed on both of them, and may be formed on one of the lower molding die 28 and the upper molding die 24. For example, when the transfer pattern is formed only on the upper molding die 24, the ultrasonic wave oscillating/receiving array 40 may be provided on the upper molding die 24.

According to the molding apparatus and the molding method described above, the mold touch and the state of the molding material in the molding die can be determined with a high degree of accuracy by obtaining the intensity of the ultrasonic wave reflective echo in the ultrasonic wave reflective echo image. By proceeding the molding process on the basis of the result of determination, the time required for the molding process can be reduced, and the occurrence of defective molding can be restrained.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although an embodiment of the present invention has been described in detail, it should be understood that various changes, substitutions, and alterations could be made hereto without departing from the spirit and scope of the invention.

1. A molding apparatus comprising:
two metal molds arranged at positions opposed to each other and each having a die for molding a member into a desired shape;
a heating unit for heating the member;
an ultrasonic wave transmitting and receiving unit arranged on the metal mold, for irradiating the member with an ultrasonic wave and receiving the reflected ultrasonic wave;
a drive unit for driving at least one of the metal molds; and
a control unit for detecting a partial contact of the member with respect to the metal mold using wave readings from the ultrasonic wave transmitting and receiving unit and for controlling the drive unit to adjust a pressing velocity of the metal mold.

2. The molding apparatus according to claim 1, wherein the control unit performs a control on the drive unit to stop a pressing operation of the metal mold when a surface contact between the metal mold and the member is detected using wave readings from the ultrasonic wave transmitting and receiving unit after having detected the partial contact.

3. The molding apparatus according to claim 1, wherein the control unit performs a temperature control on the heating unit to lower the temperature of the member when melting of the member is detected using wave readings from the ultrasonic wave transmitting and receiving unit at the time of heating of the member for molding, and the control unit performs a separating control on the drive unit for moving the metal mold and the member away from each other when solidification of the member is detected using wave readings from the ultrasonic wave transmitting and receiving unit at the time of cooing of the member for molding.

4. The molding apparatus according to claim 1, wherein when a space is detected between the member and the metal mold using wave readings from the ultrasonic waver transmitting and receiving unit during the heating, the control unit notifies the detection to an operator.

5. The molding apparatus according to claim 1, wherein the control unit determines that the metal mold and the member are not in contact with each other when a reflective wave that the ultrasonic waver transmitting and receiving unit receives is different from the transmitted ultrasonic wave in phase, the control unit determines that the member is in the solid state when the ultrasonic wave transmitting and receiving unit detects two of the reflective waves at different times and when a second reflective wave detected later is weaker than a first reflective wave detected earlier, and the control unit determines that the member is in a molten state when the second reflective wave is stronger than the first reflective wave.

6. A molding method comprising:
arranging a member between two metal molds arranged at positions opposed to each other;
heating the member;
bringing the metal molds toward each other at a first velocity;
detecting a partial contact of the metal mold and the member using an ultrasonic wave transmitting and receiving unit provided on one of the metal molds; and
controlling the velocity of movement of the metal mold to a second velocity which is different from the first velocity.

7. The molding method according to claim 6, wherein the movement of the metal mold is stopped when a surface contact between the metal mold and the member is detected using the ultrasonic wave transmitting and receiving unit after having detected the partial contact.

8. The molding method according to claim 6, wherein when melting of the member is detected using the ultrasonic wave transmitting and receiving unit at the time of heating of the member for molding, the temperature of the member is lowered, and when solidification of the member is detected using the ultrasonic wave transmitting and receiving unit at the time of cooling of the member for molding, the metal mold and the member are moved away from each other.

9. The molding method according to claim 6, wherein when a space is detected between the member and the metal mold using the ultrasonic wave transmitting and receiving unit at the time of heating, a signal is provided to an operator.

10. The molding method according to claim 6, wherein when a reflective wave that the ultrasonic wave transmitting and receiving unit receives is different from the transmitted ultrasonic wave in phase, the member is determined to be free of contact with the metal mold, and when the ultrasonic wave transmitting and receiving unit detects two of the reflective waves at different time and a second reflective wave detected later is weaker than a first reflective wave detected earlier, the member is determined to be in a solid state, and when the second reflective wave is stronger than the first reflective wave, the member is determined to be in a molten state.
